(19) United States
(12) Patent Application Publication
(10) Pub. No.: US 2025/0370588 A1
(43) Pub. Date: Dec. 4, 2025

(54) SYSTEM AND METHOD FOR GENERATING AN OUTPUT TO A GRAPHICAL USER INTERFACE

(71) Applicant: Carlos Cicchelli, Fayetteville, GA (US)

(72) Inventor: Carlos Cicchelli, Fayetteville, GA (US)

(73) Assignee: Ideas To Move Forward LLC, Sheridan, WY (US)

(21) Appl. No.: 18/731,651

(22) Filed: Jun. 3, 2024

(51) Int. Cl. G06F 3/04817; G06F 9/451

(52) U.S. Cl. CPC G06F 3/04817; G06F 9/451

(57) ABSTRACT

A technique for generating an output to a graphical user interface to improve the operation of a computing device, the system constructed according to the technique may include receiving, by a processor of at least one computing device, a plurality of information from a user; analyzing, with the at least one computing device the plurality of information; generating, by the at least one computing device, an output to a graphical user interface having user interaction icons on a lower portion and a side portion of the interface.

### BACKGROUND

Mobile computing device users spend an average of 4.5 hours per day on their devices in the U.S. Currently, there is no system and/or method for determining the most efficient interaction for the user with the graphical user interface of the computing device. The lack of a system and/or method decreases the efficiency of the computing device.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for generating a graphical user interface display may include receiving, by a processor of at least one computing device, a plurality of information from a user, analyzing, with the at least one computing device the plurality of information; generating, by the at least one computing device, an output to a graphical user interface having user interaction icons on a lower portion and a side portion of the interface.

### BRIEF DESCRIPTION OF THE DRAWINGS

Embodiments of the inventions are illustrated in the figures. However, the embodiments and figures are illustrative rather than limiting; they provide examples of the invention.

FIG. 1 depicts an illustration of an exemplary computing device.

FIG. 2 depicts an example of a method for providing a user customized graphical user interface.

FIG. 3 depicts an example of a method for providing a user customized graphical user interface.

FIG. 4 depicts an example illustration of a system set up for providing a user customized graphical user interface.

FIG. 5 depicts an example illustration of a system set up for providing a user customized graphical user interface.

FIG. 6 depicts an example illustration of a user customized graphical user interface.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

There is a need for computing devices that provide efficient means of user interaction with a graphical user interface. In some embodiments, a system and method for determining a user interaction with an interface of a computing device reduces the cognitive load of a user by analyzing a user interaction of a system and methods and determining a user customized interaction that utilizes the computing device more efficiently. Furthermore, the system and methods improve the efficiency of the computing device by reducing drain on the battery i.e., efficient user interaction with the graphical user interface decreases the amount of time the display is operating, thus reducing battery drain. Additionally, the system and methods decrease processing load on the processor i.e., the less time the user spends interacting with the graphical user interface the overall decreased load on the processor.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of electronic devices, user interfaces for such devices, and associated processes for using such devices are described. In some embodiments, the device is a portable communications device, such as a mobile telephone, that also contains other functions, such as PDA and/or music player functions. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the generation component of an output to a graphical user interface to be displayed on a screen, the display is integrated with the computer system. In some embodiments, the display generation component is separate from the computer system. As used herein, “generating” includes causing to display an output on a screen of graphical user interface (e.g., data rendered or decoded by the computing device) by transmitting, via a wired or wireless connection, data to an integrated or external display generation component to visually produce the graphical user interface.

The device typically supports a variety of applications, such as one or more of the following: a gaming application, a telephone application, a video conferencing application, an e-mail application, an instant messaging application, a workout support application, a photo management application, a digital camera application, a digital video camera application, a web browsing application, a digital music player application, a video browsing application, and/or a digital video player application.

The various applications that are executed on the device optionally use at least one common physical user-interface device, such as the touch-sensitive surface i.e., graphical user interface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

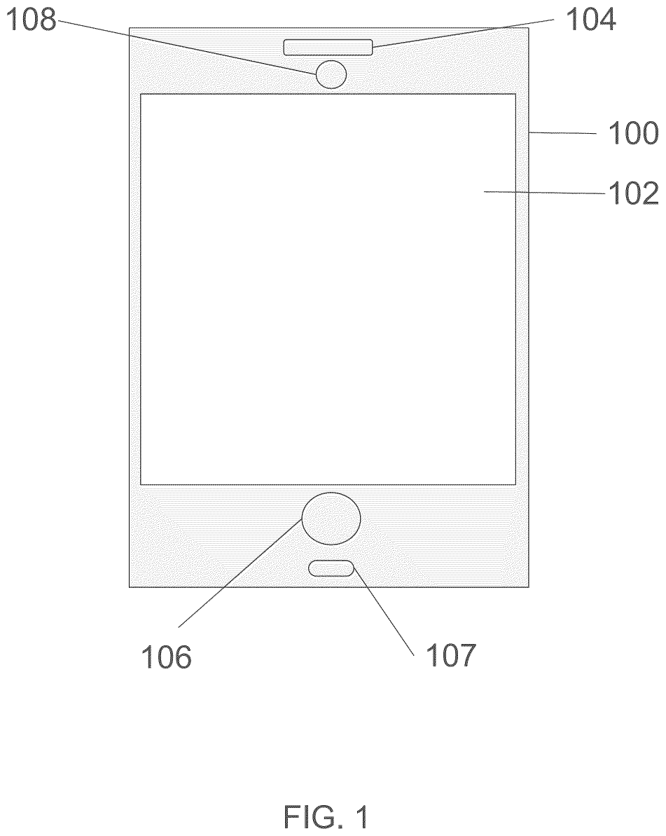

FIG. 1 depicts an illustration of an illustrative computing device 100 having a touch-sensitive surface that serves a graphical user interface 102 of a computing device 100. The illustrative computing device 100 may include a memory (not shown) (which optionally includes one or more computer readable storage mediums), a memory controller (not shown), one or more processing units (CPU's) (not shown), peripherals interface (not shown), RF circuitry (not shown), audio circuitry (not shown), speaker 104, microphone 107, input/output (I/O) subsystem (not shown), other input or control devices (not shown), and external ports (not shown). Computing device 100 optionally includes one or more optical sensors (not shown) and camera 108.

The illustrative computing device 100 in FIG. 1 may include fewer or more components than are illustrated in FIG. 1. The illustrative computing device 100 in FIG. 1 may optionally include one or more buttons such as button 106 for interacting with the computing device 100.

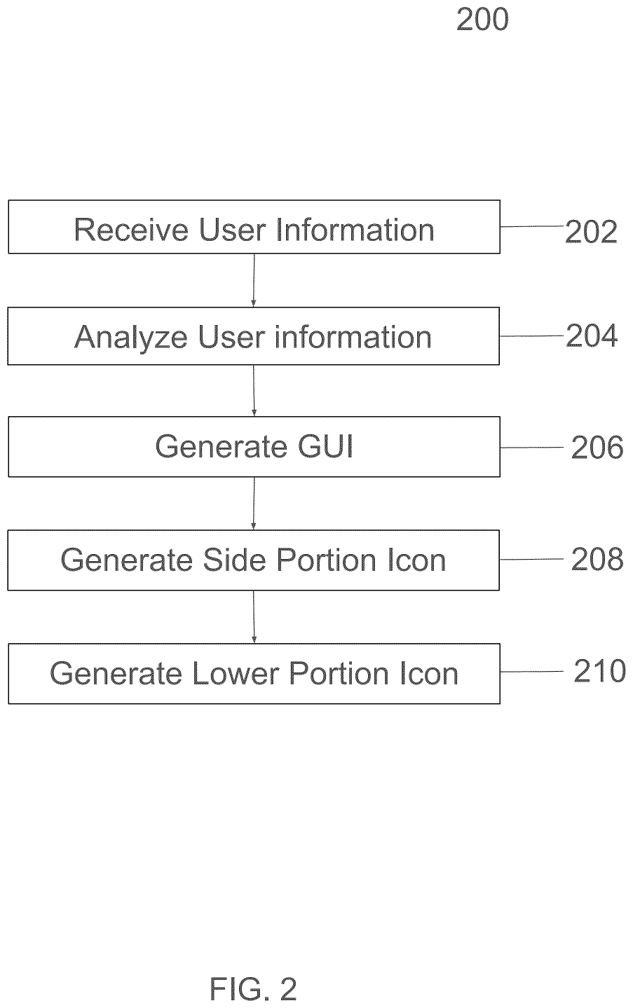

As shown in FIG. 2 the method of flowchart 200 starts at step 202 in which a plurality of user information is received the plurality of information may include information related to hand dominance of the user in the form of user input or may include any one or all of passively collected information such as images captured with camera 108 and/or information related to GPS position and/or movement e.g., accelerometer of the computing device 100. In some embodiments at step 204 the method may then analyze, with the at least one computing device the plurality of information input by the user and/or the passively collected information. In some embodiments at step 206 the method may then generate an output graphical user interface based on the analysis at step 206. In some embodiments at step 208 the method may generate an output to the graphical user interface of at least one user interaction icons in a left hand (LH) arrangement on a left side portion of the graphical user interface based on the analysis at step 206. In some embodiments at step 210, the method may generate an output to the graphical user interface by the at least one computing device, at least one user interaction icon on a lower portion in a left hand (LH) arrangement of the graphical user interface based on the analysis at step 206.

As shown in FIG. 2 the method of flowchart 200 starts at step 202 in which a plurality of user information is received the plurality of information may include information related to hand dominance of the user in the form of user input or may include any one or all of passively collected information such as images captured with camera 108 and/or information related to GPS position and/or movement e.g., accelerometer or other component capable of monitoring movement of the computing device 100. In some embodiments at step 204 the method may then analyze, with the at least one computing device the plurality of information input by the user and/or the passively collected information. In some embodiments at step 206 the method may then generate an output to a graphical user interface based on the analysis at step 206. In some embodiments at step 208 the method may generate an output to a graphical user interface at least one user interaction icons in a right hand (RH) arrangement on a right side portion of the graphical user interface based on the analysis at step 206. In some embodiments at step 210, the method may generate an output to a graphical user interface by the at least one computing device, at least one user interaction icon on a lower portion in a right hand (RH) arrangement of the graphical user interface based on the analysis at step 206.

In some embodiments, the receiving step 202 of method 200 may receive an image from a camera 108 while the user is operating the computing device 100. The method may at step 204 analyze the image based on the position of the user with respect to the camera 108 and determine based on the analysis which hand the user is using to operate the computing device 100. For example, in the case where the user is operating the computing device 100 with their right hand, the camera 108 would receive a reverse image of the user from a left profile position. In this instance, at step 204 analyze, the image the analysis may determine that the user is operating the computing device 100 with their right hand and is right hand dominant. In the opposing case where the user is operating the computing device 100 with their left hand, the camera 108 would receive a reverse image of the user from a right profile position. In this instance step 204 analyze, the analysis of the image may determine that the user is operating the computing device 100 with their left hand and is left hand dominant.

In some embodiments, the receiving step 202 of method 200 may receive information from any of a location services, GPS coordinates, accelerometer, or any other similar location tracking device from the computing device 100. In some embodiments, the computing device 100 may combine image data received from camera 108 with information from location services, GPS coordinates, accelerometer, or any similar location tracking device from the computing device 100 to perform the analysis at step 204. In some embodiments, the system and methods may collect information from location services, GPS coordinates, accelerometer information and determine an efficient arrangement of user interaction icons on the graphical user interface, for example the system and method may use a threshold to determine the most efficient arrangement of user interaction icons. In some embodiments, when the number of movements to the right or left of a center position during use of the computing device 100 exceeds a threshold the method determines a left hand dominant or right hand dominant user interaction icon arrangement. In some embodiments, the threshold may be a range of percentages such as 51% to 60%, 61% to 70%, 71% to 80%, 81% to 90%, 91% to 100%. In some embodiments, the threshold may refer to a determination from a range within a statistically derived significant difference such as 0.95 to 100, 0.85 to 0.95, 0.75 to 0.85, 0.65 to 0.75, 0.55 to 0.65.

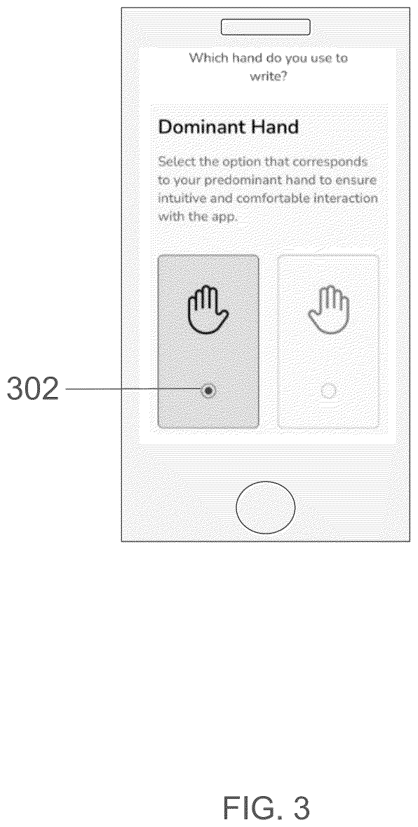

In some embodiments as shown in FIG. 3 the computing device 100 may receive an input from a user. FIG. 3 illustrates a computing device 100 displaying a graphical user interface for a hand selection in which a left hand selection button 302 has been selected. In some embodiments, the computing device 100 may only use this information in the analysis, but the computing device 100 is not limited to only using this information and may also use this information in combination with any of the aforementioned information of the computing device 100 in the analysis.

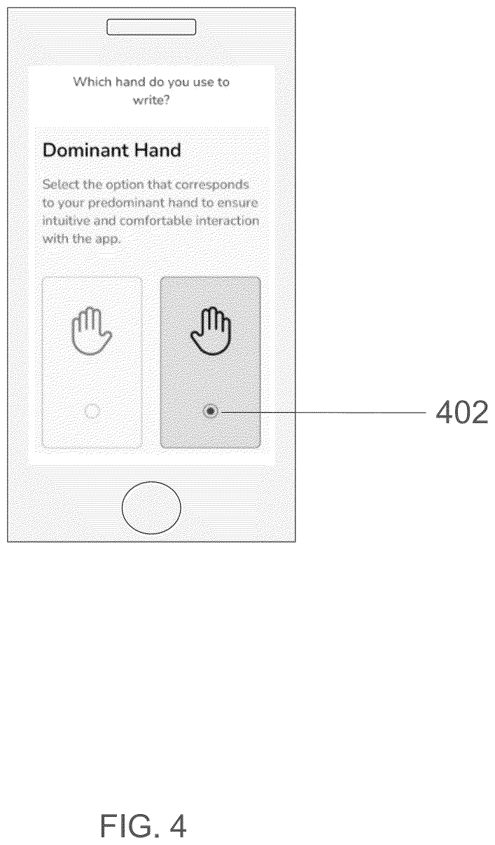

In some embodiments as shown in FIG. 4 the computing device 100 may receive an input from a user. FIG. 4 illustrates a computing device 100 displaying a graphical user interface for a hand selection in which a right hand selection button 402 has been selected. In some embodiments, the computing device 100 may only use this information in the analysis, but it is not limited to only using this information and may also use this information in combination with any of the aforementioned information of the computing device 100 in the analysis.

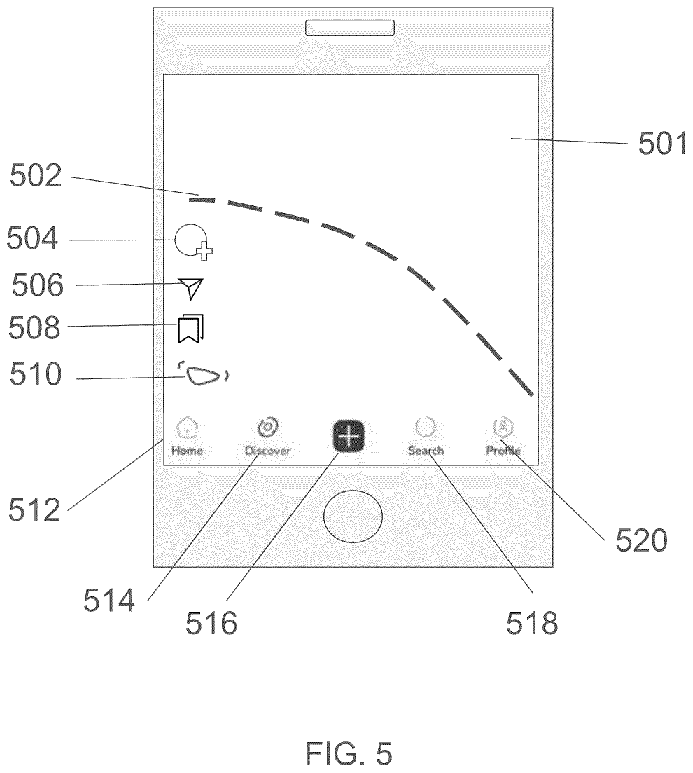

In some embodiments as shown in FIG. 5 a graphical user interface 501 having user interaction icons generated for left hand dominant use displayed on the computing device 100. In some embodiments, analysis of information may determine that the user is left hand dominant and the computing device 100 may generate a graphical user interface having user interaction icons on a left side portion 502 of the interface arranged as a follow button 504, message button 506, bookmark button 508, laugh button 510, and a lower portion left hand arrangement of home button 512, discover button 514, post button 516, search button 518, profile button 520. The system and methods are not limited to the aforementioned arrangement of user interaction icons illustrated on graphical user interface 501 and can be arranged in any combination thereof. In some embodiments the arrangement illustrated in a left side portion 502 enables a more efficient interaction of a user with the interaction icons of the graphical user interface 501.

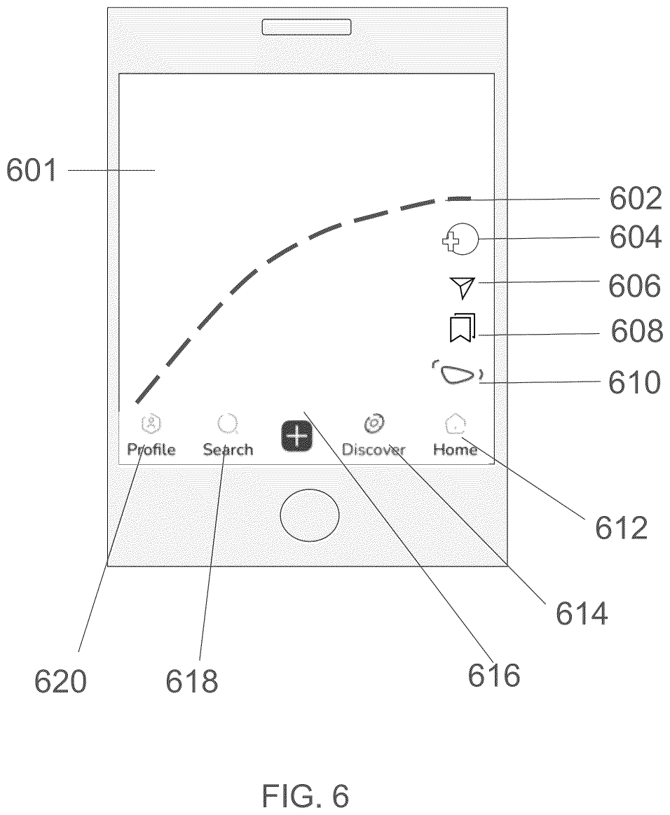

In some embodiments as shown in FIG. 6 a graphical user interface 601 having user interaction icons generated for right hand dominant use displayed on the computing device 100. In some embodiments, analysis of information may determine that the user is right hand dominant and the computing device 100 may generate a graphical user interface having user interaction icons on a right side portion 602 of the interface arranged as a follow button 604, message button 606, bookmark button 608, laugh button 610, and a lower portion left hand arrangement of home button 612, discover button 614, post button 616, search button 618, profile button 620. The system and methods are not limited to the aforementioned arrangement of user interaction icons illustrated on graphical user interface 601 and can be arranged in any combination thereof. In some embodiments the arrangement illustrated in a right side portion 602 enables a more efficient interaction of a user with the interaction icons of the graphical user interface 601.

With the foregoing description, the disclosure herein has described the subject matter of the following numbered clauses:
Clause 1. A method comprising receiving, by a processor of at least one computing device, a plurality of information of a user; analyzing, with the at least one computing device the plurality of information of the user; generating, by the at least one computing device, an output to a graphical user interface having user interaction icons on a lower portion and a side portion of the interface.
Clause 2. The method of clause 1, the analyzing the plurality of information comprising determining a left hand dominance of the user.
Clause 3. The method of clause 1, the generating the side portion user interaction icons comprising generating user interaction icons on a left side portion of the graphical user interface.
Clause 4. The method of clause 1, the analyzing the plurality of information comprising determining a right hand dominance of the user.
Clause 5. The method of clause 4, the generating the side portion user interaction icons comprising generating user interaction icons on a right side portion of the graphical user interface.
Clause 6. The method of clause 3, the generating the side portion user interaction icons comprising arranging the lower portion user interaction icons in a left dominant position.
Clause 7. The method of clause 5, the generating the side portion user interaction icons comprising arranging the lower portion user interaction icons in a right dominant position.
Clause 8. An apparatus comprising a processor; and a storage medium for tangibly storing thereon program logic for execution by the processor, the stored program logic causing the processor to perform the operations of: receiving, a plurality of information of a user; analyzing, the plurality of information, determining, a hand dominance of the user; generating an output to a graphical user interface having user interaction icons on a lower portion and a side portion of the interface.
Clause 9. The apparatus of clause 8, the analyzing the plurality of information comprising determining a left hand dominance of the user.
Clause 10. The apparatus of clause 8, the generating the side portion user interaction icons comprising generating user interaction icons on a left side portion of the graphical user interface.
Clause 11. The apparatus of clause 8, the analyzing the plurality of information comprising determining a right hand dominance of the user.
Clause 12. The apparatus of clause 8, the generating the side portion user interaction icons comprising generating user interaction icons on a right side portion of the graphical user interface.
Clause 13. The apparatus of clause 10, the generating the side portion user interaction icons comprising arranging the lower portion user interaction icons in a left dominant position.
Clause 14. The apparatus of clause 12, the generating the side portion user interaction icons comprising arranging the lower portion user interaction icons in a right dominant position.
Clause 15. A non-transitory computer readable storage medium for tangibly storing computer program instructions capable of being executed by a computer processor, the computer program instructions defining the steps of: receiving a plurality of information of a user; analyzing the plurality of information, using the at least one computing device, to determine a hand dominance of the user; utilizing, the at least one computing device to generate an output to a graphical user interface having user interaction icons on a lower portion and a side portion of the interface.
Clause 16. The computer readable storage medium of clause 15, the analyzing the plurality of information comprising determining a left hand dominance of the user.
Clause 17. The computer readable storage medium of clause 15, the generating the side portion user interaction icons comprising generating user interaction icons on a left side portion of the graphical user interface.
Clause 18. The computer readable storage medium of clause 15, the analyzing the plurality of information comprising determining a right hand dominance of the user.
Clause 19. The computer readable storage medium of clause 15, the generating the side portion user interaction icons comprising generating user interaction icons on a right side portion of the graphical user interface.
Clause 20. The computer readable storage medium of clause 17, the generating the side portion user interaction icons comprising arranging the lower portion user interaction icons in a left dominant position.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or Blu-ray-Disc, or other type of device for electronic data storage.

Although the methods and features described above with reference to FIGS. 1-6 are described above as performed using the example computing device 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-6 may be used alone without the other features and elements or in various combinations with or without other features and elements. Sub-elements of the methods and features described above with reference to FIGS. 1-6 may be performed in any arbitrary order (including concurrently), in any combination or sub combination.

What is claimed is:

1. A method comprising: receiving, by a processor of at least one computing device, a plurality of information of a user; analyzing, with the at least one computing device the plurality of information of the user; generating, by the at least one computing device, an output to a graphical user interface having user interaction icons on a lower portion and a side portion of the interface.

2. The method of claim 1, the analyzing the plurality of information comprising determining a left hand dominance of the user.

3. The method of claim 1, the generating the side portion user interaction icons comprising generating user interaction icons on a left side portion of the graphical user interface.

4. The method of claim 1, the analyzing the plurality of information comprising determining a right hand dominance of the user.

5. The method of claim 4, the generating the side portion user interaction icons comprising generating user interaction icons on a right side portion of the graphical user interface.

6. The method of claim 3, the generating the side portion user interaction icons comprising arranging the lower portion user interaction icons in a left dominant position.

7. The method of claim 5, the generating the side portion user interaction icons comprising arranging the lower portion user interaction icons in a right dominant position.

8. An apparatus comprising: a processor; and a storage medium for tangibly storing thereon program logic for execution by the processor, the stored program logic causing the processor to perform the operations of: receiving, a plurality of information of a user; analyzing, the plurality of information, determining, a hand dominance of the user; generating an output to a graphical user interface having user interaction icons on a lower portion and a side portion of the interface.

9. The apparatus of claim 8, the analyzing the plurality of information comprising determining a left hand dominance of the user.

10. The apparatus of claim 8, the generating the side portion user interaction icons comprising generating user interaction icons on a left side portion of the graphical user interface.

11. The apparatus of claim 8, the analyzing the plurality of information comprising determining a right hand dominance of the user.

12. The apparatus of claim 8, the generating the side portion user interaction icons comprising generating user interaction icons on a right side portion of the graphical user interface.

13. The apparatus of claim 10, the generating the side portion user interaction icons comprising arranging the lower portion user interaction icons in a left dominant position.

14. The apparatus of claim 12, the generating the side portion user interaction icons comprising arranging the lower portion user interaction icons in a right dominant position.

15. A non-transitory computer readable storage medium for tangibly storing computer program instructions capable of being executed by a computer processor, the computer program instructions defining the steps of: receiving a plurality of information of a user; analyzing the plurality of information, using at least one computing device, to determine a hand dominance of the user; utilizing, at least one computing device to generate an output to a graphical user interface having user interaction icons on a lower portion and a side portion of the interface.

16. The computer readable storage medium of claim 15, the analyzing the plurality of information comprising determining a left hand dominance of the user.

17. The computer readable storage medium of claim 15, the generating the side portion user interaction icons comprising generating user interaction icons on a left side portion of the graphical user interface.

18. The computer readable storage medium of claim 15, the analyzing the plurality of information comprising determining a right hand dominance of the user.

19. The computer readable storage medium of claim 15, the generating the side portion user interaction icons comprising generating user interaction icons on a right side portion of the graphical user interface.

20. The computer readable storage medium of claim 17, the generating the side portion user interaction icons further comprising arranging the lower portion user interaction icons in a left dominant position.
